(19) United States
(12) Patent Application Publication
(10) Pub. No.: US 2025/0324145 A1
(43) Pub. Date: Oct. 16, 2025

(54) DIGITAL VIDEO VIRTUAL PRODUCTION SYSTEMS AND METHODS

(71) Applicant: Red Digital Cinema, Inc., Foothill Ranch, CA (US)

(72) Inventors: Jeff Goodman, Aliso Viejo, CA (US); Loren Simons, Woodland Hills, CA (US); Graeme Nattress, Acton, Ontario (CA); Matt Biederman, Westlake Village, CA (US); Kenta Honjo, Irvine, CA (US); Uday Mathur, Westlake Village, CA (US)

(21) Appl. No.: 19/007,246

(22) Filed: Dec. 31, 2024

Related U.S. Application Data
(60) Provisional application No. 63/633,701, filed on Apr. 13, 2024.
(60) Provisional application No. 63/696,686, filed on Sep. 19, 2024.

(51) Int. Cl. H04N 21/845; H04N 21/43

(52) U.S. Cl. CPC H04N 21/8456; H04N 21/43072

(57) ABSTRACT

A virtual production system has a first computing device coupled to a first virtual production display device. A processor executes a virtual production control engine that controls the first virtual production display to alternatingly display at first and second virtual production backgrounds. When the first video camera is operating in a multi-track virtual production recording mode, the processor receives a stream of digital video image frames from a video camera. First frames in the stream capture the first virtual production background and second frames alternating with the first frames capture the second virtual production background. The processor separates the stream of the digital video image frames into a first track of the first frames and a second track of the second frames. The processor organizes the first and second track into separate monitoring streams and/or recorded files.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

Embodiments disclosed herein relate to digital video production, including for live broadcast, virtual production, and other environments. For instance, virtual production technology continues to advance, which presents challenges to manufacturers of camera and video recording/production systems.

### SUMMARY

In some aspects, the techniques described herein relate to a virtual production system including: at least a first virtual production display device; a first computing device coupled to the first virtual production display device and including one or more processors that execute a virtual production control engine, the virtual production control engine configured to control the first virtual production display device such that the first virtual production display device alternatingly displays at least a first virtual production background and a second virtual production background; and at least a first video camera including: an image sensor configured to capture digital video image frames in response to light incident on the image sensor; and one or more processors configurable, when the first video camera is operating in a multi-track virtual production recording mode, to: receive a stream of the digital video image frames from the image sensor, wherein first frames in the stream of digital video image frames capture the first virtual production background and second frames in the stream of digital image frames capture the second virtual production background, wherein the first frames and the second frames alternate in the stream of the digital video image frames; and separate the stream of the digital video image frames into a first track including the first frames and a second track including the second frames.

In some aspects, the techniques described herein relate to a virtual production system wherein the one or more processors of the first video camera are further configured to format the first track into a first file, format the second track into a second file, and record the first file and the second file in memory.

In some aspects, the techniques described herein relate to a virtual production system wherein the first virtual production background corresponds to a non-green screen virtual set and the second virtual production background corresponds to a green screen virtual set.

In some aspects, the techniques described herein relate to a virtual production system wherein one or both of the first virtual production background and the second virtual production background include recorded motion video, and the virtual production control engine is configured to provide digital video data to the first virtual production display device corresponding to the recorded motion video.

In some aspects, the techniques described herein relate to a virtual production system wherein one or both of the first virtual video production background and the second virtual production background include computer-generated imagery, and the virtual production control engine is configured to provide digital data to the first virtual production display device corresponding to the computer-generated imagery.

In some aspects, the techniques described herein relate to a virtual production system wherein the virtual production control engine is further configured to alternatingly output first digital image data corresponding to the first virtual production background and second digital image data corresponding to the second virtual production background.

In some aspects, the techniques described herein relate to a virtual production system further including a synchronization generator coupled to provide a synchronization signal to each of the first computing device and to the first video camera, the first computing device configured in response to the synchronization signal to adjust a timing of the display of the alternating display of the first virtual production background and the second virtual production background, and the first video camera configured in response to the synchronization signal to adjust a timing of the capture of the digital video image frames.

In some aspects, the techniques described herein relate to a virtual production system wherein the first virtual production display device includes an LED display.

In some aspects, the techniques described herein relate to a virtual production system wherein the first video camera includes a fiber optic port configured to connect the first video camera to a fiber optic cable, and wherein the one or more processors of the first video camera are further configured to: compress the digital video image frames into compressed raw digital motion video data, the compressed raw digital motion video data not having been demosaiced; generate network packets including the compressed raw digital motion video data; convert an electrical signal carrying the network packets into an optical signal; and provide the optical signal to the fiber optic port for real-time streaming off of the first video camera.

In some aspects, the techniques described herein relate to a video camera including: a housing; an image sensor within the housing and configured to output raw, mosaiced digital image data in response to light incident on the image sensor; and one or more processors configurable, when the video camera is operating in a multi-track virtual production recording mode, to: receive a stream of digital image frames from the image sensor at a first frame rate, wherein alternating frames in the stream of the digital image frames correspond to N virtual production environment configurations, where N is at least two; separate the digital image frames into N separate tracks; format the N separate tracks as N separate files; and record the N separate files into memory.

In some aspects, the techniques described herein relate to a video camera wherein the one or more processors are further configured, when the video camera is operating in a multi-track virtual production recording mode, to set a frame rate of the video camera to be at least N*F, where F is a frame rate of each of the N separate tracks.

In some aspects, the techniques described herein relate to a video camera wherein the one or more processors are further configured, when the video camera is operating in a multi-track virtual production recording mode, to compress the digital image frames.

In some aspects, the techniques described herein relate to a video camera wherein the compression occurs prior to the separation of the digital image frames into N separate tracks.

In some aspects, the techniques described herein relate to a video camera wherein the compression occurs after the separation of the digital image frames into N separate tracks.

In some aspects, the techniques described herein relate to a video camera further including a plurality of video streaming output ports, and the one or more processors are further configurable, when the video camera is operating in a multi-track virtual production recording mode, to output the N separate tracks for streaming off the video camera via the plurality of video streaming output ports.

In some aspects, the techniques described herein relate to a video camera further including a plurality of video streaming output ports, and the one or more processors are further configurable, when the video camera is operating in a multi-track virtual production recording mode, to output the N separate files for streaming off the video camera via the plurality of video streaming output ports.

In some aspects, the techniques described herein relate to a video camera wherein the video camera further includes a fiber optic port supported by the housing and configured to connect the video camera to a fiber optic cable, and wherein the one or more processors of the video camera are further configured to: compress the digital image frames into compressed raw digital motion video data; generate network packets including the compressed raw digital motion video data; convert an electrical signal carrying the network packets into an optical signal; multiplex the optical signal using wavelength division multiplexing; and provide the multiplexed optical signal to the fiber optic port for real-time streaming off of the video camera.

In some aspects, the techniques described herein relate to a video camera wherein the fiber optic port includes an SMPTE compliant connector.

In some aspects, the techniques described herein relate to a video camera wherein the fiber optic port includes an SPTME 304M compliant connector configured to mate with an SMPTE 311M compliant cable.

In some aspects, the techniques described herein relate to a video camera wherein the housing includes a camera body housing containing the image sensor and a module housing releasably attached to the camera body housing, wherein the module housing supports the fiber optic port.

In some aspects, the techniques described herein relate to a video camera wherein the one or more processors include at least a first processor within the camera body housing and at least a second processor within the module housing.

In some aspects, the techniques described herein relate to a video camera wherein the first processor performs compression, and the second processor performs the generation of the network packets, the converting of the electrical signal, and the providing of the optical signal.

In some aspects, the techniques described herein relate to a video camera wherein the compressed raw digital motion video image data has not been demosaiced into a full color digital image.

In some aspects, the techniques described herein relate to a video camera wherein the compressed raw digital motion video data has not been color processed.

In some aspects, the techniques described herein relate to a video camera wherein the compressed raw digital motion video data has not been tonally processed.

In some aspects, the techniques described herein relate to a video camera wherein the compressed raw digital motion video data has not been white balanced.

### BRIEF DESCRIPTION OF THE DRAWINGS

Embodiments of this disclosure will now be described, by way of non-limiting example, with reference to the accompanying drawings, like reference numerals can refer to similar features throughout.

FIGS. 1A-1C depict an embodiment of a virtual production environment including a group of light emitting diode (LED) volume panels, during time periods in which the LED volume walls are respectively projecting a day landscape scene, a night landscape scene, and a green screen.

FIG. 2 depicts an example of a video production system that can form part of a virtual production environment such as the one of FIGS. 1A-1C, according to certain embodiments.

FIG. 3A is a plot showing timing of various events in a multi-track recording scenario implemented by a video production system according to certain embodiments.

FIG. 3B shows multiple virtual production tracks that can be recorded or streamed by a video camera in a virtual production system according to certain embodiments.

FIG. 4A-4C respectively depict front, rear, and perspective views of an embodiment of a digital video camera capable of recording or streaming multiple tracks, such as for recording in a virtual production environment.

FIGS. 4D and 4F depict the camera of FIGS. 4A-4C with a streaming module attached, and FIG. 4E depicts a streaming module detached from the camera.

FIG. 5A depicts a schematic block diagram of a video camera, such as the video camera of FIGS. 4A-4D and 4F.

FIG. 5B depicts a schematic block diagram of a streaming module, such as the streaming module of FIG. 4E.

FIG. 6 depicts a schematic block diagram of an image processing system of a video camera, such as the image processing system of the video camera of FIG. 5A, according to certain embodiments.

FIG. 7A depicts an embodiment of a system for streaming, processing, and delivering multi-track digital video.

FIG. 7B depicts an embodiment of a system for storing multi-track streamed video via a network to network storage.

FIG. 7C is a block diagram showing an example of a camera capable of streaming multi-track video directly to storage.

FIG. 8 shows a flow chart of image processing and decompression techniques that can be performed by a post-processing computing device, such as the processing engines of FIG. 7A, or by a video camera, according to certain embodiments.

FIG. 9 shows an example of a fiber optic cable, such as SMPTE 311M compliant cable.

FIG. 10 shows an example of wavelength division multiplexing.

### DETAILED DESCRIPTION OF CERTAIN EMBODIMENTS

The following description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

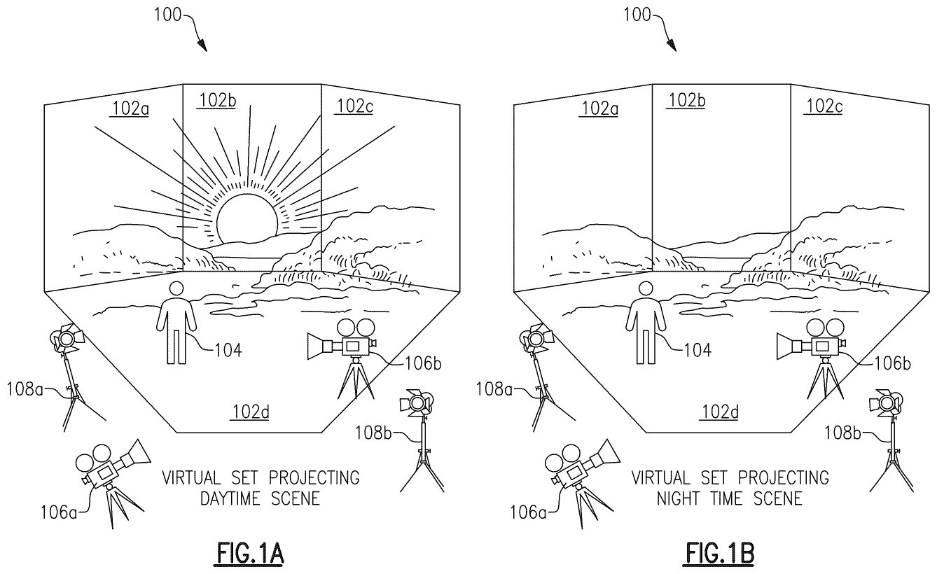

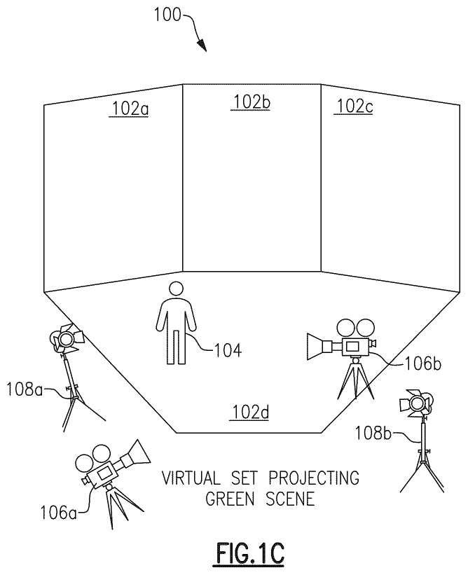

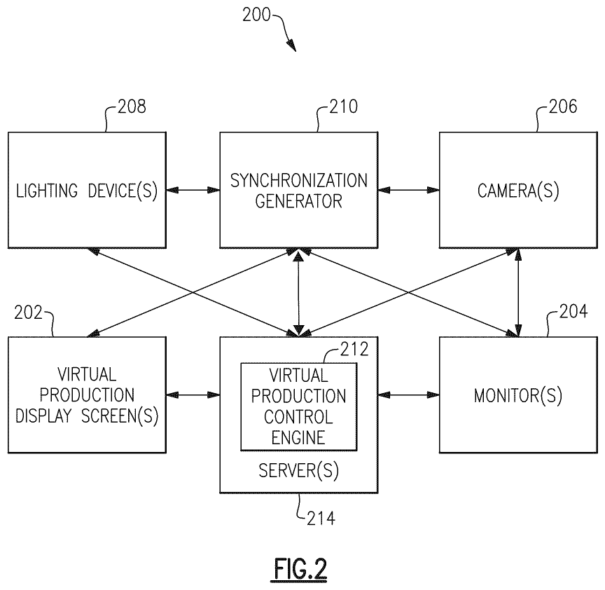

FIGS. 1A-1C depict an embodiment of a virtual production environment 100 including a group of virtual production display screens or panels 102, during time periods in which the virtual production screens 102 are projecting a day landscape scene (FIG. 1A), a night landscape scene (FIG. 1B), and a green screen (FIG. 1C).

While FIGS. 1A-1C depict landscape, night, and green screen scenes, this is only for the purposes of illustration. Users can configure the screens 102 to display a wide variety of different scenes depending on the use case. For instance, users can configure the screens 102 display only a single non-green scene instead of both day and night scenes, facilitating recording of a single non-green screen track together with a green screen track, instead of three tracks. Or, as another example, instead of day and night scenes, the virtual production panels 102 in a different use case can be configured to display a first scene with overlaid sub-titles or other text in a first language and a second scene with overlaid sub-titles or other text in a second language, facilitating simultaneous recording of tracks for audiences that speak two different languages. Moreover, the screens 102 can be configured to display four or more different scenes (e.g., day, night, day augmented overlaid graphics/text, night augmented with overlaid graphics/text), facilitating recording of four or more tracks.

The virtual production panels 102 can include one or more digital displays such as a plurality of LED-based displays. In some embodiments, the virtual production panels 102 are so called “LED volumes” or “LED volume walls.” LED volumes can provide advantages over other types of virtual production technologies, such as static green screens, because LED volumes can achieve more realistic footage by creating realistic reflections and shadows, thereby enhancing the authenticity of the virtual environment 100, and can also provide actors, directors, and other personnel with real-time scene context.

As will be discussed in further detail, the virtual production panels 102 can be driven by a computer graphics software application running on one or more computers, such as the Unreal Engine provided by Epic Games, Inc., or some other 3D graphics engine.

The particular arrangement of the virtual production panels 102a-102d in the illustrated virtual production environment 100 includes three vertical panels 102a-102c and a floor panel 102d. The virtual production panels 102 can be connected to a digital video source, such that the virtual production panels 102 can be configured to project generally any type of recorded or computer-generated scene.

Depending on the use case, in other embodiments other types of display technology (e.g., liquid crystal displays [LCD]) and/or other numbers of panels can be used. For example, while not shown in FIG. 1A-1B for simplicity, the virtual production panels 102 can include one or more ceiling panels above the wall panels 102a-102c, opposite the floor panel 102d, and which can display a sky, building ceiling, etc., depending on the scene.

In the illustrated environment 100, an actor 104 is standing on the floor panel screen 102d in front of the three wall panel screens 102a-102c. The environment 100 further includes one or more digital video cameras 106a, 106b is positioned to record the actor 104 and the virtual production panels 102. The cameras can record independent feeds or can record tracks for combination, such as to generate 3-dimensional footage depending on the use case. The cameras 106a, 106b can also be configured to record and/or stream separate tracks corresponding to a plurality of virtual production scenes. For example, the cameras 106a, 106b can be configured through a menu setting or other appropriate user input to record two, three, four, or more separate tracks corresponding to an equal number of different scenes displayed by the virtual production screens 102. In the scenario depicted by FIGS. 1A-1C, for instance, as will be discussed in further detail, the cameras 106a, 106b can be configured by the user to record three tracks, one corresponding to each of the day scene, the night scene, and the green screen scene, to synchronize the capture of the scenes with the changing of the scenes by the virtual production screens 102. The cameras 106a, 106b can further be configured to separate out the three tracks for recording as discrete files or for streaming separately, such as to separate camera serial digital interface (SDI) or other output ports.

The environment 100 further includes one or more lighting devices 108a, 108b arranged to provide custom lighting to the environment 100. For example, the lighting devices 108a, 108b can be LED-based studio light panels, which can include an array of bi-color (e.g., warm and cool) LEDs or red-green-blue (RGB) LEDs and which can be controlled to adjust the output intensity and/or color. A wide variety of other lights can be used, depending on the implementation.

In some embodiments, the lighting devices 108a, 108b can be similar to or the same as virtual display screens 102 (e.g., an LED volume), but configured to provide lighting instead of background.

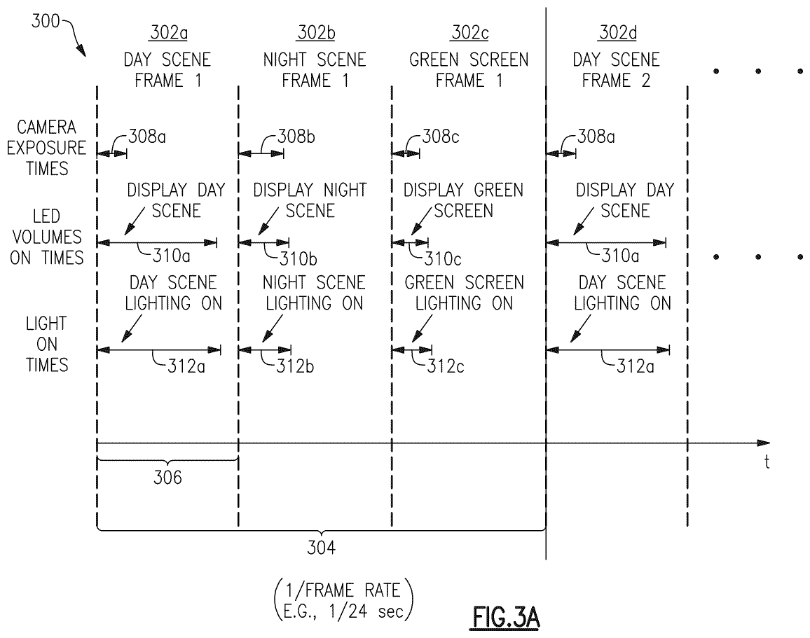

FIG. 2 shows an example of an example of such a video production system 200 according to certain embodiments, and which can be used with the virtual production environment of FIGS. 1A-1C.

The illustrated system 200 includes one or more virtual production display screens 202, one or more monitors 204, which can be any type of display for monitoring streamed or recorded video or background, one more cameras 206, one or more lighting devices 208, a synchronization generator 210, and a virtual production control engine 212 executing on one or more servers or other computing devices 214.

As shown, the virtual production control engine 212 can be coupled to some or all the other components in the system 200 via digital video cables (e.g., optical or copper) or networking cables (e.g., copper Ethernet cables), or via another appropriate type of cable or wireless connection. The control engine 212 can include one or more software applications executing on the servers 214 and configured to orchestrate the virtual production. For instance, the control engine 212 can include a computer graphics engine for generating, rendering, and/or manipulating imagery for displaying on the display screens. The imagery can include computer-generated imagery, recorded video or still images, or a combination thereof. For example, the control engine 212 can include the Unreal Engine or another 3D graphics engine.

The control engine 212 can also provide a user interface allowing users to adjust various settings, such as to adjust or swap the background scenery displayed on the display screens 202, to adjust the lighting provided by lighting devices 208, to control operation of the cameras 206, select which background or camera feeds go to which of the monitors 204, etc.

The virtual production display screens 202 can include the virtual production panels 102a-102d of FIGS. 1A-1C, such as one or more LED volume panels, or any other type of virtual production display.

The cameras 206 can be any of the cameras described herein (e.g., with respect to FIGS. 1 and 4-6) configured for recording and/or streaming multiple tracks of video, e.g., where each track corresponds to a different background projected by the virtual production display screens 202.

The lighting devices 208 can be the lighting devices 108 of FIGS. 1A-1C, or some other type of video production lighting devices. For instance, in some embodiments, the lighting devices 208 are LED screens and, like the virtual display screens 202, can be driven by the Unreal Engine or another computer graphics engine, to provide lighting effects customized and synchronized to the scene that is currently displayed on the virtual display screens 102a-102d. In some cases, one or more of the lighting devices 108 can be configured to be dedicated to providing lighting while the display screens 202 are projecting a first background scene and one or more other lighting devices 208 can be dedicated to providing lighting while the display screens 202 are projecting a second, different scene. As one example, referring to FIG. 1A-1C, the first lighting device 108a could be configured to operate to provide lighting customized to the daytime scene, while the virtual production panels 102a-102d are projecting the daytime scene, and the second lighting device 108b could be configured to provide lighting customized to the nighttime scene, only while the virtual production panels 102a-102d are projecting the night time scene. For example, the virtual production control engine 212 could operate to synchronize such operation of the lighting devices 208 with operation of the display screens 202, by activating and deactivating the respective lighting devices 208 synchronous with the display screens 202.

The monitors 204 can be coupled to the cameras 206 and/or the virtual production control engine 212 to allow for live viewing of various feeds or playback of recorded video. For example, referring to FIGS. 1A-1C for the purposes of illustration, in one implementation, the monitors 204 include three separate video displays each coupled via a cable to a different SDI output port of the first camera 106a, each SDI output port providing one of a day scene track, a night scene track, and a green screen track captured by first camera 106a. The monitors 204 in this implementation further include three additional displays each coupled via a cable to a different SDI output port of the second camera 106b, each SDI output port providing one of a day scene track, a night scene track, and a green screen track captured by the second camera 106b. In this exemplary implementation the monitors 204 can further include three additional displays each coupled via a cable to a different output provided by the servers 214, where each output provides one of a video feed corresponding to the day scene, a video feed corresponding to the night scene, or a video feed corresponding to the green screen. For example, the outputs from the servers 214 can provide a duplicate of the video streams generated by the virtual production control engine 212 and provided to the virtual production display screens 202. In this fashion, the monitors 204 can provide simultaneous viewing of separate streamed or played back tracks captured by each of the first and second cameras 106a, 106b during display of the day scene, night scene, and green screen track, as well as viewing of the different background feeds (e.g., video or CGI feeds) themselves. In other implementations, there is not a separate monitor for every feed, and instead one or more of the monitor(s) are segmented to present multiple feeds in different portions of a single display.

As shown, the synchronization generator 210 can be configured to provide Genlock or other synchronization signals to some or all the other components in the system 200 to synchronize operation of the various devices to a common video frame boundary.

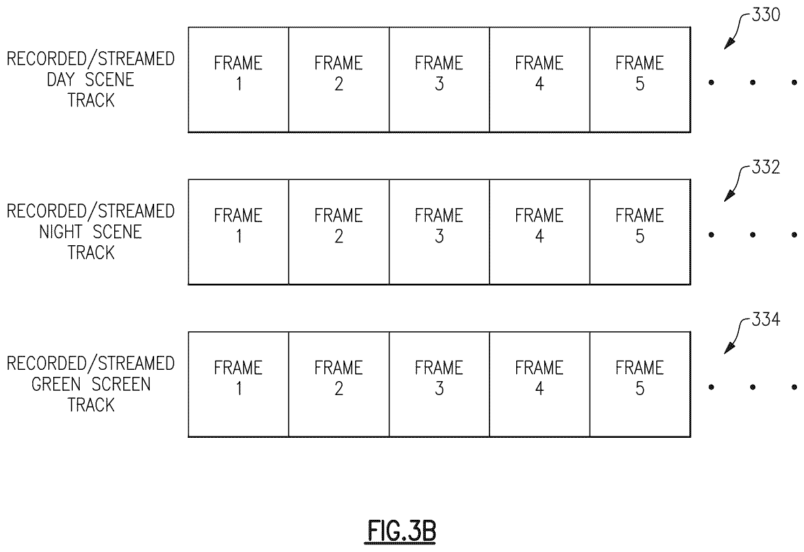

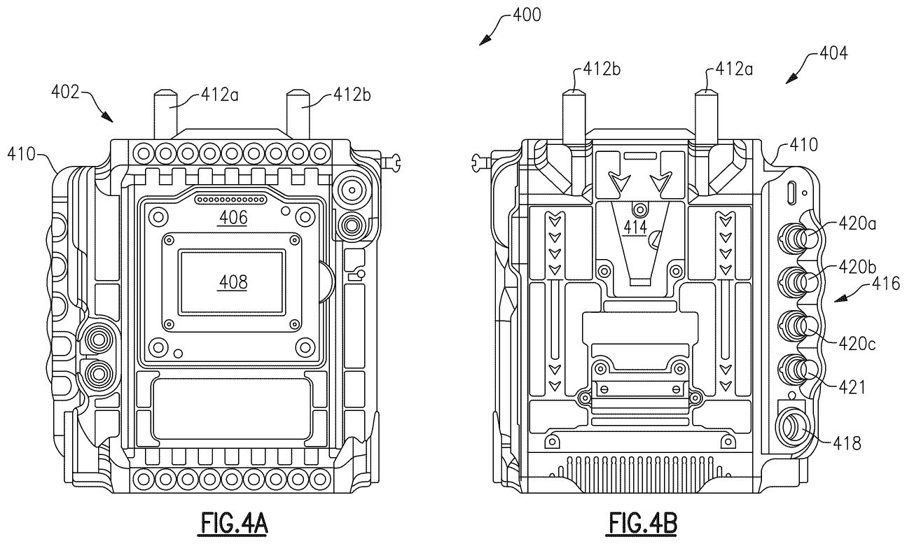

FIG. 3 is a timing diagram 300 illustrating operation of an example virtual video production system, which will be described with reference to the systems of FIGS. 1A-1C and FIG. 2. In the exemplary scenario, the camera(s) 206 are configured to capture three tracks including a day scene track, a night scene track, and a green scene track. The timing diagram 300 shows operation during windows 302a, 302b, 302c during which a first frame is captured for each of the three respective tracks. FIG. 3 also shows operation during window 302d during which the second frame is captured for the day scene track. While FIG. 3 shows only a first frame and one-third of a second frame for the purposes of illustration, it will be appreciated that additional frames continue to be captured on an alternating basis during operation.

An effective frame period 304 of each track is one divide by an effective frame rate of the tracks. Because the individual frames for each track are captured sequentially within the effective frame period 304, the individual frames are each captured within a smaller sub-frame period 306. As one example, where the effective frame rate of each track is 24 frames per second (fps), the effective frame period 304 is 1/24 of a second, and the sub-frame period 306 is one-third of the effective frame period, i.e., 1/72 of a second. Thus, while the effective frame rate of each track is 24 fps in this example, the actual frame rate of the camera(s) 204 is set to at least 72 fps to allow for sequential capture of three frames during each effective frame period 304, one frame for each of the day, night, and green screen tracks.

As shown, the camera(s) 202 can be configured to have exposure times 308a, 308b, 308c for each track, e.g., during which pixels of an image sensor of the camera(s) 206 are activated to detect light. The exposure times 308a, 308b, 308c can all be the same or can vary based on the track. For example, in the illustrated embodiment, the day scene track has a shorter exposure time 308a than either of the exposure time 308b of the night scene track or the exposure time 308c of the green screen track. The virtual production control engine 212 can be configured to control the camera(s) 206 to set the exposure times, or a user can set the exposure times using an interface of the camera(s) 206, depending on the embodiment.

The virtual production display screens 202 can be controlled by the virtual production control engine 212 to have on-time periods 310a, 310b, 310c corresponding to the different virtual backgrounds. For example, in the illustrated embodiment, the control engine 212 outputs a video stream to the display screen(s) 202 causing it to display the day scene for an on-time period 310a during a portion of the sub-frame window 302a, then changes the video stream to cause the screen(s) 212 to display the night scene for an on-time period 310b during a portion of the next sub-frame window 302b, and then changes the video stream to cause the screen(s) 212 to display the green screen for an on-time period 310c during a portion of the third sub-frame window 302c. The on-time period 310a for displaying the day scene can be significantly longer (e.g., 2, 3, 5, 10, 100 or more times longer) than the on-time periods 310b, 310c for displaying the night and green screen scenes. This can cause the day scene to be visible to individuals physically present in the virtual production environment, whereas because the on-time periods 310b, 310c of the night scene and green screen scenes are much shorter, the night scene and green screen turn on and off too fast for the user to actually see them, while at the same time providing sufficient time for the camera(s) 206 to capture them during the exposure times 308b, 308c, respectively. In this manner, the system 200 can display a single visible background to those in the production environment while simultaneously recording multiple backgrounds. The virtual production control engine 212 can be configured via a user interface to allow the user to select a different scene for visibility on set. For example, if the user selects the night scene as the currently visible background, the control engine 212 can increase the on-time 310b of the night scene and shorten the on-time 310a of the day scene.

The lighting devices 208 can also be controlled by the virtual production control engine 212 to have on-time periods 312a, 312b, 312c corresponding to the different virtual backgrounds.

For example, in the illustrated embodiment, the control engine 212 controls one or more of the lighting devices 208 to output lighting for an on-time period 312a during a portion of the sub-frame window 302a corresponding to the day scene. The on-time period 312a may be the same as the on-time period 310a of the display screen(s) 202, for example. The control engine 212 may be configured to activate a subset of the lighting devices 208 or all of the lighting devices 208 during the first sub-frame window 302a. For example, referring to FIGS. 1A-1C, in one implementation, the first lighting device 108a is dedicated to providing lighting during the day scene, and the control engine 212 controls the first lighting device 108a to activate during the first sub-frame window 302a while the second lighting device 108b is off. The control engine 212 may provide a lighting control input to the first lighting device 108a to cause the first lighting device 108a to output light that is customized to the day scene, for example.

Similarly, the control engine 212 controls one or more of the lighting devices 208 to output lighting for an on-time period 312b during a portion of the sub-frame window 302b corresponding to the night scene. The on-time period 312b may be the same as the on-time period 310b of the display screen(s) 202, for example. The control engine 212 may be configured to activate a subset of the lighting devices 208 or all of the lighting devices 208 during the second sub-frame window 302b. For example, referring to FIGS. 1A-1C, in one implementation, the second lighting device 108b is dedicated to providing lighting during the night scene, and the control engine 212 controls the second lighting device 108b to activate during the second sub-frame window 302b while the first lighting device 108a is off. The control engine 212 may provide a lighting control input to the second lighting device 108b to cause the second lighting device 108b to output light that is customized to the night scene, for example.

The control engine 212 can additionally control one or more of the lighting devices 208 to output lighting for an on-time period 312c during a portion of the sub-frame window 302c corresponding to the green screen scene. The on-time period 312c may be the same as the on-time period 310c of the display screen(s) 202, for example. The control engine 212 may be configured to activate a subset of the lighting devices 208 or all of the lighting devices 208 during the third sub-frame window 302c. For example, referring to FIGS. 1A-1C, in one implementation, both the first and second lighting device 108a, 108b may be configured to provide lighting during the green screen scene, and the control engine 212 controls the first and second lighting devices 108a, 108b to activate during the third sub-frame window 302c. The control engine 212 may provide a lighting control input to the lighting devices 108a, 108b to cause the lighting devices 108a, 108b to output light that is customized to the green screen scene, for example.

While FIG. 3A illustrates a scenario where the camera exposure time windows 308, LED volume on time windows 310, and light on time windows 312 each begin at the beginning of the respective track windows 302, in some embodiments, the camera(s) 206 can be configured (e.g., by user through a GUI) to move the beginning of the exposure times 308 within the respective window 302, such as to the middle, towards the end, or to another position within the respective track window 302. Similarly, the control engine 212 can control the virtual production display screens 202 and/or lighting devices to move the LED volume on time windows 310 and/or light on time windows 312 to be synchronized with the respective camera exposure time window 308, e.g., such that the entirety of each exposure time window 308 falls within the respective LED volume on time window 310 and/or respective light on time window 312. Moreover, while in the illustrated embodiment each of the sub-frame periods 306 are the same, and the three track windows 302 per frame are therefore of the same duration, which is ⅓ of the frame period 304 in FIG. 3A, in other cases, the sub-frame period 306 can vary between the different track windows 302 (e.g., based on user configuration through a GUI). In one such case, the day scene track window 302a consumes ½ of the frame period 304, the night scene track window 302b consumes ¼ of the frame period 304, and the green screen track window 302c consumes the remaining ¼ of the frame period 304. Moreover, this configurability of the duration of the track windows 302 can be combined with the ability to move the exposure time windows 308, the LED volume on time windows 310, and the light on time windows 312 within the respective track window 302.

FIG. 3B shows multiple virtual production tracks 330, 332, 334 that can be recorded or streamed by a video camera in a virtual production system according to certain embodiments. As shown, each track comprises a plurality of image frames, each of which can be represented as a compressed or uncompressed image. The camera(s) 206 can record the tracks 330, 332, 334 as three separate logically organized and independently accessible files having appropriate metadata. The files can be R3D files compressed using RED Digital Cinema's R3D compressed RAW file format, for example. The camera(s) 206 can also be configured to stream the tracks 330, 332, 334 off camera as three separate compressed or uncompressed streams, e.g., to separate SDI ports of the camera(s) 206, either in real time for live viewing or when playing back tracks that have been recorded to the camera(s) memory.

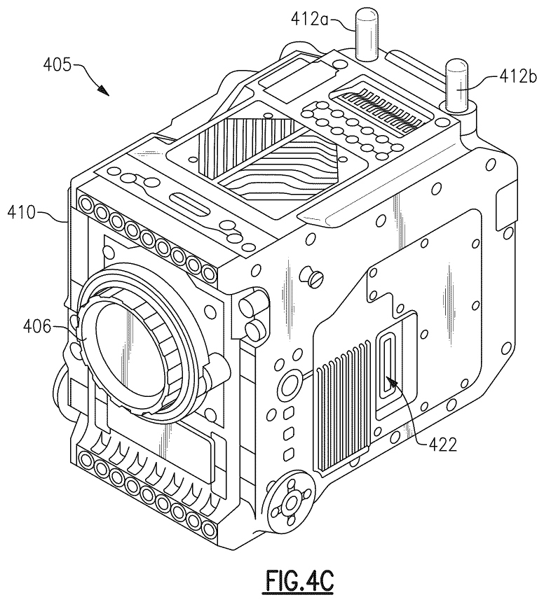

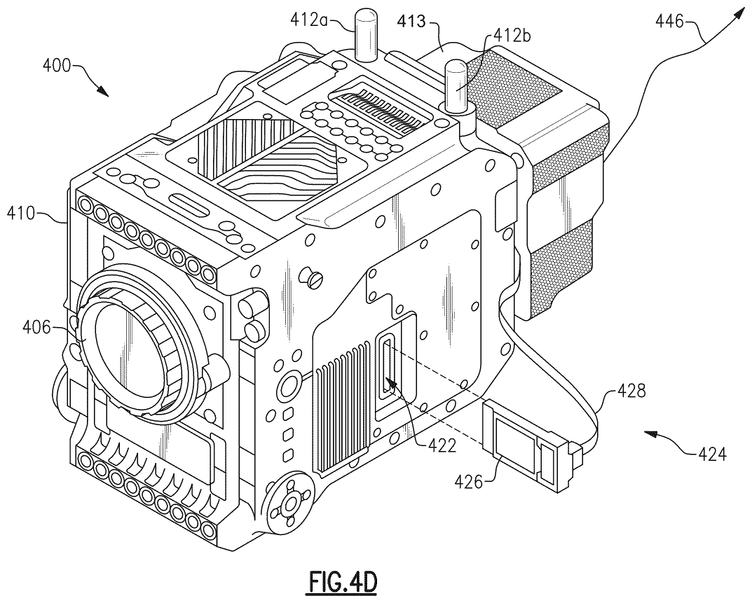

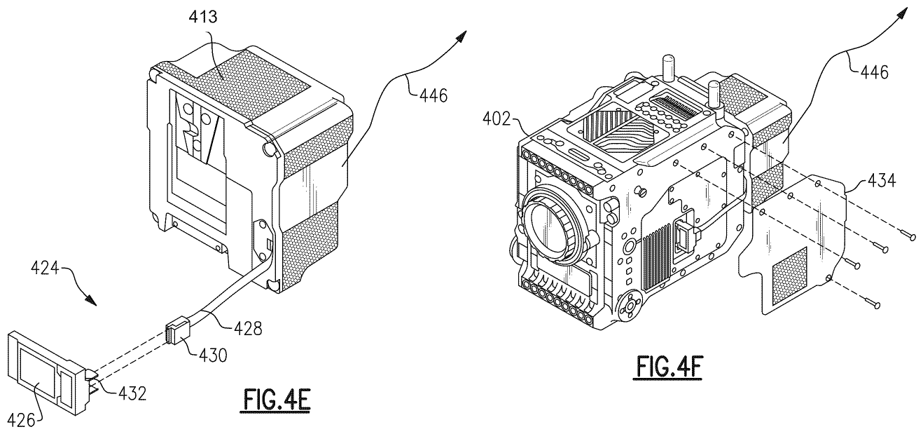

FIG. 4A-4C respectively depict front 402, rear 404, and perspective 405 views of an embodiment of a digital video camera 400 capable of recording or streaming multiple tracks, such as for recording in a virtual production environment. For example, the camera 400 of FIG. 4 can be one of the cameras 106a, 106b of FIGS. 1A-1C or the camera 206 of FIG. 2.

The camera 400 includes an interface 406 for attaching a lens mount 407 (shown in FIG. 4C). The front of the camera body 410 has a window 408 (shown in FIG. 4A) providing access for light to enter the camera housing 410 and be detected by an image sensor arranged within the camera housing 410.

The camera 400 includes a pair of antennas 412a, 412b for sending and receiving wireless signals. For example, the first antenna 412a can be a Wi-Fi antenna and the second antenna 412b can an Ambient Communications Network (ACN) antenna configured to receive wireless Genlock and Timecode signals, e.g., for synchronizing camera operation to an external source such as a timecode generator providing timestamps to each camera.

A v-mount 414 is supported by the rear of the camera housing 410 is provided for releasably attachment of a battery or other module to the housing. A connection interface includes a DC power input port 418, three SDI ports 420a-420c (e.g., 12G-SDI ports) for connecting to SDI monitor(s), and a Genlock port 421 for receiving a Genlock signal. For example, the synchronization generator 210 of FIG. 2 can be coupled to the camera 400 via a cable connected to the Genlock port 421 or wirelessly via the antenna 412b to provide Genlock or Timecode signals. Moreover, the camera 400 can be connected to up to three monitor(s) 204 via the SDI ports 420a-420c.

As shown in FIG. 4C, the housing of the camera 500 can include a memory card slot 422 for receiving a CF memory card or other memory device for storing video files, including compressed raw video files for multiple separate files corresponding to different virtual production backgrounds, for example.

FIG. 4D shows the camera 400 with a streaming module 413 attached to the v-mount interface 414. The streaming module 413 includes an adapter 424 configured to insert into the memory card slot 122 in place of a memory card. The adapter 424 is generally configured to convert the storage location into a port for streaming compressed raw footage out of the camera body 410. For example, in the illustrated embodiment, the adapter 424 can be configured to stream compressed raw footage output from the memory card slot 422 to the streaming module 413 via a connection cable 428. In the embodiment of FIG. 4D, the storage location is a memory card bay or slot 422 that, in an on-board storage mode of operation, releasably receives the memory card, but when the camera 400 is in a module streaming mode of operation, receives compressed raw (or uncompressed depending on the capture mode) footage output by the compression module to the CF card bay 422 and communicates the compressed raw footage in real-time to the to the streaming module 413. The adapter 424 includes a head 426 dimensioned to be releasably inserted into the memory card slot 422 and a cable 428 connected at one end to the head 426 and at another end (not shown) to a port on the streaming module 413, such that the cable 428 communicates captured footage (e.g., multi-track compressed raw footage) received by the head 426 to the streaming module 413.

The head 426 of the adapter 424 can include an electro/mechanical interface with a set of pins or contacts that generally mimics that of a CF card so as to engage with a corresponding interface in the memory card slot 422. The cable 428 can be a ribbon cable including one or more copper conductors configured as a serial digital channel, or any other appropriate type of wired means for communicating the data to the streaming module 413. In alternative embodiments, a wireless channel may be used, e.g., using one or more of the antennas 412a, 412b. A processor within the streaming module 413 can receive the compressed raw digital data stream from the cable 428, process the data, and stream the data out of the streaming module 413 via a fiber optic cable 446, such as an SMPTE 311M cable.

FIG. 4E shows a view of the adapter 424 and its connection to the streaming module 413. As shown, the cable 428 and head 426 can be releasably connected to one another via male and female connection interfaces 430, 432. A v-mount interface 427 of the module 404 can mate with the v-mount interface 414 of the camera body 410. FIG. 4F shows that the adapter 424 can be concealed by a cover 434 attachable in the illustrated embodiment to the camera body 402 via a set of screws.

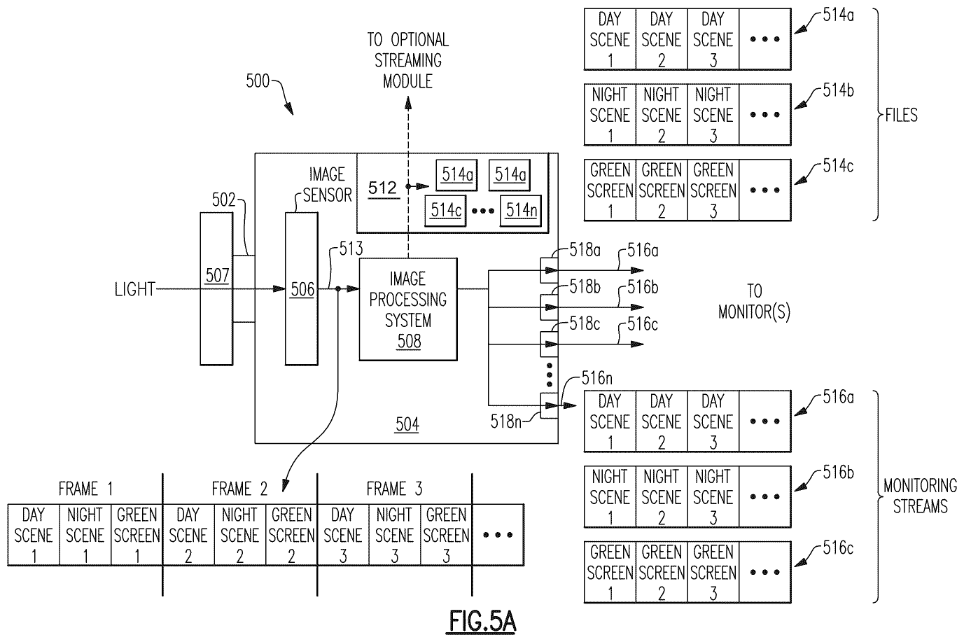

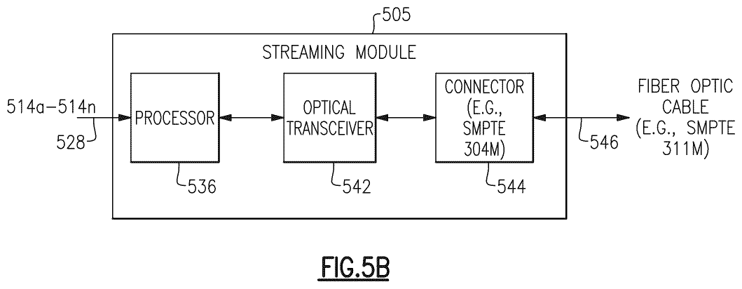

FIG. 5 depicts a schematic block diagram of a video camera 500, such as the video camera of FIGS. 4A-4D and 4F. The camera 500 includes a lens mount 502, which can be fixedly or releasably attached to the camera body housing 504. The lens mount 502 is configured to accept a lens 507 (e.g., a standard lens or a fisheye lens).

An image sensor 506 is contained within the camera body housing 504 and is arranged such that light focused by the lens is detected by an array of pixels of the image sensor 506. The image sensor 506 converts light into digital video image data

The image sensor 506 can be for example, but without limitation, CMOS, CCD, or a multi-sensor array using a prism to divide light between the sensors. The image sensor 506 can be a CMOS global shutter sensor, for example, configured to capture all pixels substantially simultaneously, resulting in reduced distortion or “Jello-effect” when the subject is moving. In other embodiments, a digital rolling shutter can be used. The image sensor 506 can further include a color filter array such as a Bayer pattern filter that outputs data representing magnitudes of red, green, or blue light detected by individual photocells of the image sensor 506. In some configurations, video camera 500 can be configured to output video at “2 k” (e.g., 2048×1152 pixels), “4 k” (e.g., 4,096×2,540 pixels), “4.5 k,” “5 k,” “6 k,” “8 k” (e.g., 8192×4320), “16 k”, or greater resolutions. As used herein, in the terms expressed in the format of “xk” (such as “2 k” and “4 k” noted above), the “x” quantity refers to the approximate horizontal resolution. As such, “8 k” resolution can correspond to about 8000 or more horizontal pixels, “4 k” resolution can correspond to about 4000 or more horizontal pixels and “2 k” can correspond to about 2000 or more pixels, etc. The image sensor 506 can provide variable resolution by selectively outputting only a predetermined portion of the image sensor 506. For example, the image sensor 506 or the processing system 508 can be configured to allow a user to identify, configure, select, or define the resolution of the video data output. Additional information regarding sensors and outputs from sensors can be found in U.S. Pat. No. 8,174,560, the entire disclosure of which is hereby incorporated by reference herein.

The image sensor 506 outputs raw digital image data mosaiced according to the color filter array, such as the example Bayer pattern color filter array. The image processing system 508 can be implemented by software or firmware executing on one or more processors within the camera body housing 504, although in some embodiments the image processing system 508 or portions thereof can be implemented in specialized hardware such as an application-specific integrated circuit (ASIC).

The image processing system 508 receives the raw mosaiced digital image data from the image sensor 506 and can perform one or more functions on the raw mosaiced digital image data to aid in compressing the image data while maintaining the raw, mosaiced nature of the digital image data, and while maintaining substantially visually lossless image quality through compression. According to some embodiments, examples of functionality that can be provided by the image processing system 508 are described in U.S. Pat. No. 10,582,168, which is hereby incorporated by reference herein in its entirety.

The processing system 508 can be configured to compress and/or otherwise process continuous video, e.g., at frame rates of 23.98, 24, 25, 29.97, 30, 47.96, 48, 50, 59.94, 60, 72, 120, 250, frames per second, or other frame rates between these frame rates or greater.

The image processing system 508 can receive a serial stream 513 of frames captured by the image sensor 506 at a rate that is at least n times the frame rate of the n individual tracks. For example, if the user sets the camera 500 to record two tracks (n=2) corresponding to two different virtual production backgrounds at 30 fps, or if a user configures the virtual production control engine 212 to set the camera 500 accordingly, the camera 500 can respond to this setting to internally configure the sensor 506 to capture sequential frames at 2*30 fps=60 fps, where each frame alternates between the two virtual backgrounds. Or if as in the illustrated implementation the camera 500 is set to record tracks at 24 fps, the camera 500 can respond by internally configuring the sensor 506 to capture sequential frames at 3×24 fps=72 fps, where the frames alternate between day, night, and green screen frames.

The image processing system 508 receives the image frame stream 513 from the image sensor 506, performs image processing on the frames as desired (e.g., to compress each frame, organizes the frames into separate tracks, organizes the tracks into files such as by adding appropriate metadata, and writes the tracks into separate files 514a-514n in a memory card or other type of memory device 512. FIG. 5A shows three example tracks for the day scene, the night scene, and the green screen virtual backgrounds. The image processing system 508 can further embed synchronization information in the captured image stream 513 and thus into the recorded and streamed footage, such as timestamp or other synchronization metadata received from a timecode generator, thereby allowing for frame accurate synchronization across multiple cameras having different local clocks.

Moreover, when a streaming adapter such as the adapter 424 of FIG. 4D is inserted into the memory slot of the camera 500, the camera image processing system 508 can stream the files 514a-514n off to a streaming module such as the module 405 of FIG. 4D (not shown in FIG. 5A). While organized logically into separate files 514a-514n, the image processing module 508 can package the files 514a-514n for delivery to the streaming module 413 via a serial data channel such as the cable 428 of the adapter 424 of FIG. 4D.

In addition to being capable of writing the separate files 514a-514n to the memory device 512 or to the streaming module 413, the camera 500 can output the separate tracks as separate monitoring streams to 516a-516n to a plurality of output monitor ports 518a-518n. For example, the three monitor ports 518a-518c in some embodiments can be the three monitor ports 420a-420c of the camera 400 of FIGS. 4A-4C.

FIG. 5B shows a schematic diagram of a streaming module 505 that can be attached to the camera 500, such as the streaming module 413 of FIGS. 4D-4F. The streaming module 505 receives the files via the adapter cable 528 other connection between the camera 500 and the streaming module 505 and communicates the footage (e.g., compressed raw R3D files corresponding to the separate tracks) to a processor 536 within the streaming module 505, which can comprise one or more processors within the streaming module housing, or custom circuitry such as an ASIC in other embodiments.

Referring to both FIG. 4D and FIG. 5B, in alternative embodiments, the adapter 424 may not be included, and the compressed raw footage can be streamed to the streaming module 505 in other ways. For example, in one embodiment, the camera body 410 includes a wired connection between the image processing system 508 and the processor 536 that extends from the image processing system 508 to a mated connection (e.g., a set of mated pins and corresponding contacts) between a module interface of the camera body 410 and a camera interface of the streaming module 505, and finally to the processor 536 within the streaming module 505.

The processor 536 can perform a variety of functions to condition the received data. For example, the processor 536 can process the digital compressed raw video footage for delivery via Internet Protocol (IP) over a fiber optic cable 546 (e.g., a SMPTE 311M cable). For instance, processor 536 can packetize and otherwise condition the data received from the adapter cable 528 (e.g., serial digital data) as appropriate for communication via IP. The processor 536 can output the processed (e.g., packetized) IP data to an optical transceiver 542. Depending on the embodiment, data can be sent via different IP-compliant video transport protocols, such as SMPTE 2110 incorporating real-time transport protocol (RTP), or secure reliable transport protocol (SRT).

The optical transceiver 542 can include an optical transmitter and, in some embodiments, also an optical receiver configured to convert electrical signals received from the processor 536 into optical signals for delivery via the fiber optic connector 544 and the fiber optic cable 546, which can be an SMPTE 304M compliant connector and an SMPTE 311M compliant cable, respectively. For example, the optical transmitter may include a voltage to current converter configured coupled optical source or emitter, which in turn feeds an optical coupler, which connects the optical source to the fiber optic cable 546. One or more components of the optical transceiver 542 may reside in the connector 544, depending on the embodiment.

The optical transceiver 542 or other appropriate component within the streaming module 505 can be configured to implement wavelength-division multiplexing (WDM). For example, the optical transceiver 542 can divide the signals corresponding to the compressed raw digital video data into a plurality of optical carrier signals using different wavelengths (e.g., colors) of laser light, and multiplex those optical carrier signals on to a smaller number (e.g., one or two) optical fibers within the fiber optic cable 546, thereby multiplying the effective capacity and throughput of the fiber optic cable 546.

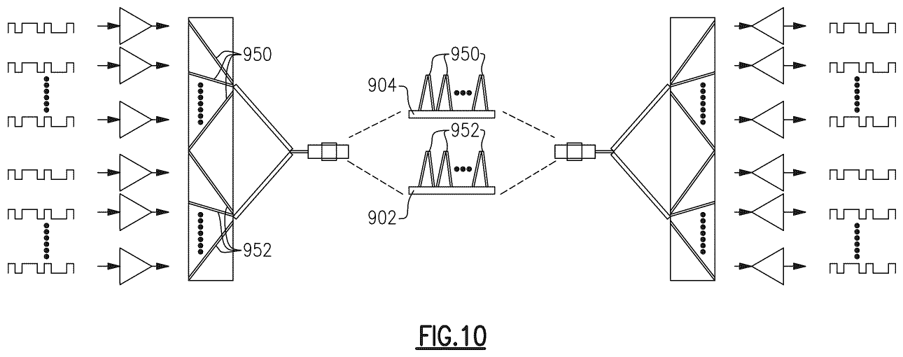

In one embodiment, the fiber optic cable 546 can be the cable 900 of FIG. 9 and have two optical fibers 902, 904 within a casing of the fiber optic cable 546. Referring to FIG. 10, the optical transceiver 542 can divide the signals corresponding to the video data (e.g., compressed raw video data) into multiple different optical carrier signals 950 for delivery via the first optical fiber 902 and into multiple different optical carrier signals 952 for delivery via the second optical fiber 904. The optical transceiver 542 can multiplex the multiple optical carrier signals for the first optical fiber 902 onto the first optical fiber 902, such as in the manner illustrated in FIG. 10. Similarly, the optical transceiver 542 can multiplex the multiple optical carrier signals for the second optical fiber 904 onto the second optical fiber 904, also in the manner illustrated in FIG. 10. In another embodiment, the video footage may be communicated using WDM on only a single optical fiber, or on more than two fibers. In some embodiments, the optical cable 546 has only a single optical fiber or has more than two fibers.

The processor 536 and/or optical transceiver 542 of the streaming module in some embodiments can operate to output the multiple tracks of recorded video onto the cable 546 such that one or more first tracks are communicated on a first optical fiber 902 and one or more second tracks are communicated on the second optical fiber 904. The processor 536 and/or optical transceiver 542 of the streaming module can alternatively or additionally operate such that different tracks are communicated via different optical carrier signals within the optical fibers. As an example, where there are four different recorded tracks corresponding to four different virtual backgrounds, the first track can be communicated on a first optical carrier signal via the first optical fiber 902, the second track can be communicated on a second optical carrier signal via the first optical fiber 902, the third track can be communicated on a third optical carrier signal via the second optical fiber 904, and the fourth track can be communicated on a fourth optical carrier signal via the second optical fiber 904.

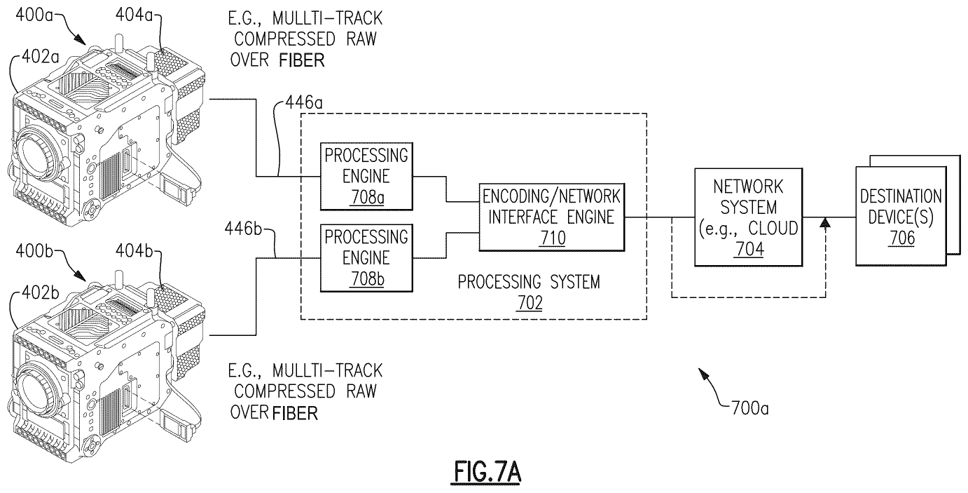

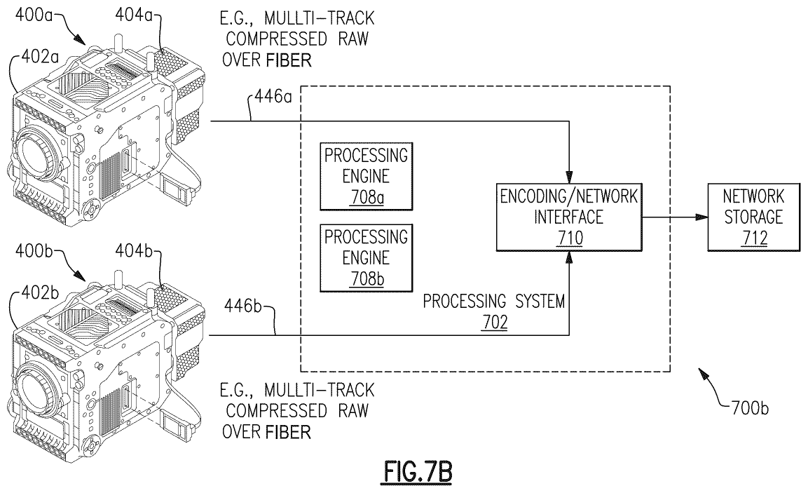

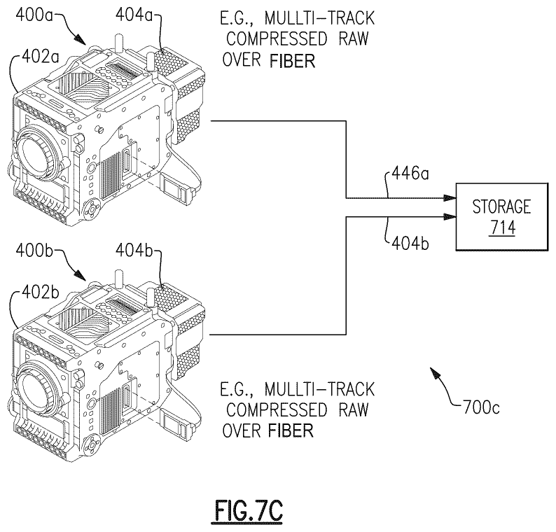

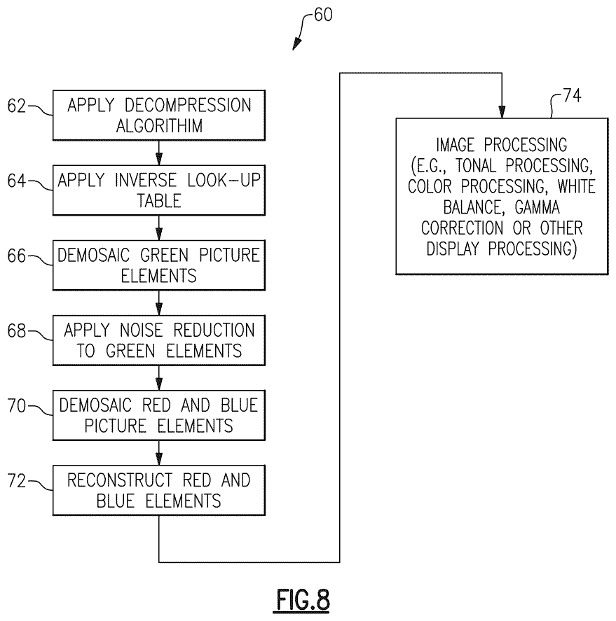

In some embodiments, the fiber optic cable 546 can be configured for duplex communication, and in such cases the streaming module 504 can be configured to receive data (e.g., control or video, audio, or other data) from a far end connection (e.g., the processing system 702 of FIG. 7A) over the fiber optic cable 546. For example, where there are two optical fibers in the cable 546, one may be permanently or temporarily dedicated to transmission and the other may be permanently or temporarily dedicated to receive, or both may be used to both transmit and receive.

Such techniques can allow the video camera to real-time stream compressed raw video footage (e.g., 4 k, 8 k, or 16 k, or higher compressed raw footage) at 10 Gbps per second or more in some embodiments. In some embodiments, the video camera can real-time stream compressed raw video footage (e.g., 4 k, 8 k, 16 k, or higher compressed raw footage) at 25 Gbps or more.

While FIGS. 4A-4F and 5A-5B show implementations of cameras where a streaming module 413, 505 is separate from the camera body, in other implementations, the functionality shown and described with respect to the streaming modules can be incorporated into an integrated camera body.

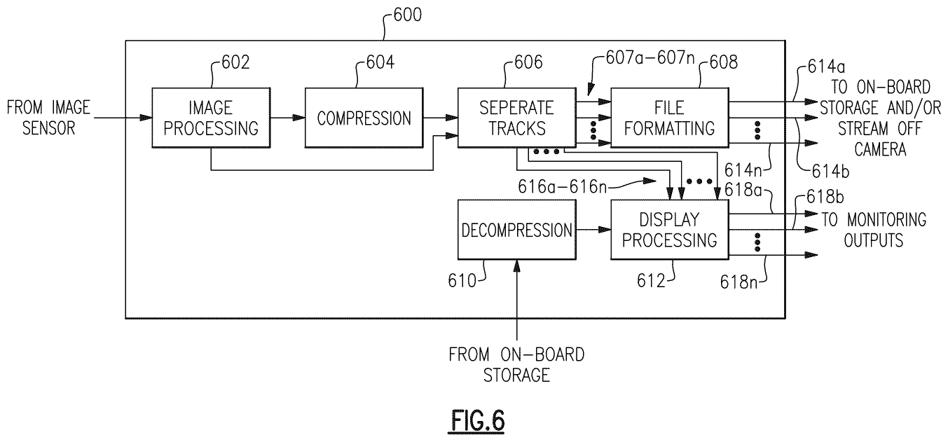

FIG. 6 shows an example of image processing system 600, such as the image processing system 508 of FIG. 5A. The image processing system 600 can comprise software or firmware implemented one or more microprocessors, or one or more ASICs or other custom hardware, or any combination thereof.

The image processing system 600 includes an image processing unit 602 that receives the image frame stream from the image sensor and performs appropriate image processing. As an example, where the camera 500 is configured to record or stream compressed raw data, the image processing unit 602 can be configured to perform a pre-emphasis compression tuning operation and/or green average subtraction (GAS) operation to the raw mosaiced Bayer pattern image frames received from the image sensor 506 and output the processed image data to the compression unit 604. U.S. Pat. No. 10,582,168, which is hereby incorporated by reference herein in its entirety, describes examples of image processing modules and corresponding operations (e.g., pre-emphasis, GAS, Green-GAS, and de-noising) that can be incorporated into the image processing unit 602. The image processing unit 602 can perform the pre-emphasis using mathematical functions such as those described in the '168 patent, or with Look Up Tables (LUTs). In some other embodiments, the image processing unit 602 performs one of the pre-emphasis functions described in U.S. Pat. No. 11,818,351, which is hereby incorporated by reference herein in its entirety.

The compression unit 604 can be configured to a compression algorithm to the processed image frames received from the image processing unit 602, such as a mathematically lossy wavelet or discrete-cosine-transform based compression algorithm, e.g., to achieve compression ratios in excess of 4:1, 5:1, 6:1, 8:1, 10:1, or 12:1 or more and remain visually lossless or substantially visually lossless.

U.S. Pat. No. 10,582,168 or U.S. Pat. No. 11,818,351, the entireties of the disclosures of which are hereby incorporated by reference herein, describe examples of image processing and compression modules and corresponding operations that can be incorporated into the image processing unit 602 and the compression unit 604.

For example, the image processing system 600 and compression unit 604 can be configured together to compress the raw mosaiced image frames received by the image sensor into compressed raw mosaiced video image frames. Following compression, the compressed image data according to embodiments described herein continues to be raw mosaiced image data, or compressed raw mosaiced image data (for example, mosaiced according to a Bayer pattern color filter array or according to another type of color filter array). The compressed raw image data can be “raw” in the sense that the video data is not “developed”, such that certain image processing image development steps are not performed on the image data prior to compression and storage. Such steps can include one or more of color interpolation (for example, de-Bayering or other de-mosaicing), color processing, tonal processing, white balance, and gamma correction. For example, the compressed raw image data can be one or more of mosaiced (for example, not color interpolated or demosaiced into a full color image), not color processed, not tonally processed, not white balanced, and not gamma corrected. Rather, such steps can be deferred for off-board the camera, such as for off-board post-processing, thereby preserving creative flexibility instead of “baking in” or fixing particular processing decisions and resulting visual look into the compressed image data in camera. In this manner, creative flexibility is preserved because customized image processing steps can be applied following decompression and demosaicing, e.g., in post-processing. Thus, the image processing unit 602 and the compression unit 604 can compress the image data from the image sensor into compressed raw image data by relatively high compression ratios while remaining visually lossless or substantially visually lossless. Additionally, although the image data has been transformed (e.g., by the subtraction of green image data), the transformation can reversible. Moreover, the compressed image data according to certain implementations is still raw. For example, the compressed raw data can be decompressed, gamma corrected or otherwise display processed, color corrected, tonally processed and/or demosaiced using any custom version of those processes that the user desires.

A track separation unit 606 receives the compressed image frames from the compression module 604 and separates the image frames into n tracks, where n is determined in response to a camera setting that is selected based on how many different virtual production backgrounds the virtual production display screens 202 are currently displaying. For example, referring to the example shown in FIG. 5A, the day scene, night scene, and green screen frames each correspond to every third frame. The track separation unit 606 extracts each compressed day scene frame, each night scene frame, and each green screen frame from a serial stream of compressed frames received from the compression unit 604, organizes the respective extracted frames into three separate streams, and outputs the streams to the file formatting unit 608. In other implementations, the track separation unit 606 can be positioned before the image processing unit 602 and compression unit 604.

The file formatting unit 608 receives the n separated tracks 607a-607n of compressed image frames and formats the tracks into three separate files. The file formatting unit 608 can organize the data within the frames into a specific file format. As one example, the file formatting unit 608 can organize the files according to the REDCODE RAW R3D file format. In some embodiments, the file formatting unit 608 organizes the files in a resolution-based format such as any of those described in U.S. Pat. No. 9,906,764, the entirety of the disclosure of which is hereby incorporated by reference herein. The file formatting unit 608 outputs n files 614a-614n corresponding to the n separate files for writing to the camera memory device or for streaming files off of the camera.

The image processing unit 602 can also output a separate stream directly to the track separation unit 606, thereby bypassing the compression unit 604. This can be for recording to memory or streaming uncompressed files 614a-614n via a streaming adapter, after processing by the file formatting unit 608, or for streaming uncompressed streams 618a-618n for monitoring via the monitoring outputs. In such cases, the image processing unit 602 may apply certain processing steps to the image data such as certain denoising operations, but without applying any processing steps related to compression, like pre-emphasis compression tuning or green-average subtraction.

As shown, the track separation unit 606 can additionally output separated tracks 616a-616n (e.g., uncompressed image data), e.g., for monitoring purposes to a display processing unit 612. The display processing unit 612 can receive the separated tracks and apply certain image processing operations, such as gamma correction or other display processing functions customized to one or more monitors/displays connected to the camera. The display processing unit 612 outputs the processed tracks 618a-618n. For instance, referring to FIG. 5A, the processed tracks 618a-618n can be output to the output ports 518a-518n. The image processing system 600 can further include a decompression module 610 that can decompress recorded footage stored in on-board camera storage and provide it to the display processing unit 612 for streaming to the monitoring outputs.

FIG. 7A depicts an embodiment of a system 700a for streaming, processing, and delivering multi-track digital video (e.g., compressed or uncompressed raw footage) captured using one or more of the cameras described herein. For example, the illustrated system 700a includes one or more cameras 400a, 400b, which can be any of the cameras described herein, although other cameras capable of real time streaming of multi-track footage can be used.

While two cameras 404a, 404b are shown for the purposes of illustration, there can a single camera or any other number of cameras (e.g., 4, 10, 25, 50, or 100 or more cameras) depending on the environment and use case.

The respective streaming modules 404a, 404b stream multi-track footage (e.g., compressed or uncompressed raw footage) in real time via optical cables 446a, 446b, which can be dual fiber SMPTE 311M cables, for example, such as is shown in FIG. 9, or any other type of optical cable. In the illustrated embodiment, the cameras 400a, 400b are coupled via the optical cables 446a, 446b to a processing system 702, which is in turn coupled to a cloud system 704, which is itself coupled to one or more destination devices 706.

The processing system 702 can comprise a group of one or multiple computing devices operating specialized software and/or firmware for processing the video footage received from the cameras 100a, 100b.

As examples, the processing system 702 could include one or more computers within a video production vehicle such as an outside broadcasting (OB) van or production truck, or some other production control room or other building or vehicle with one or more servers or other computers.

The illustrated processing system 702 can include one or more processing engines 708a, 708b and an encoding/network interface engine 710, each of which can run on separate computing devices, or one or more of which can run on shared computing devices depending on the implementation.

The processing system 702 can include an interface for connecting to the respective optical cables 446a, 446b. For example, where the optical cables are SMPTE 311M compliant cables, the interface of the processing system 702 can include an SMPTE 304M compliant connector for each camera 404a, 404b. The processing system 702 can further include an optical transceiver for each connector that includes at least an optical receiver for detecting the received optical signals and converting the optical signals to electrical signals. For example, optical transceiver can include optical detectors configured to detect the laser light transmitted over the optical cables and convert it to electrical signals, as is generally illustrated on the right side of FIG. 10. The optical transceivers can also include transmitters for providing duplex communication back to the cameras 404a, 404b, for duplex communication.

The cables 446a, 446b can each comprise one contiguous cable, or multiple cables connected via a series of repeaters or other connectors, such that each cable 446a can span a relatively long distance (e.g., at least 10, 50, 100, 500, 1000, 2000, or 3000 meters or more). Thus, for example, the cables 446a, 446b can be part of existing SMPTE 311M cabling infrastructure in a production site such as a concert, TV or movie production site, stadium, or the like.

Depending on the embodiment, the interface of the processing system can further include hardware and/or software/firmware for recovering, from the converted electrical signals, the original network packetized IP data generated by the cameras 104a, 104b.

Depending on the embodiment, the interface (e.g., the 304M connectors, optical transceivers, and IP processing software/firmware) can be included on one or more computers that implement the processing engines 708a, 708b, or at some other appropriate location in the processing system 702, such as a dedicated interface device that connects to the processing engines 708a, 708b.

The processing engines 708a, 708b can be configured to perform real time decompression/decode, demosaicing, and other image processing (e.g., tonal processing, color processing, white balance, gamma correction and/or other display processing) on the decompressed image data.

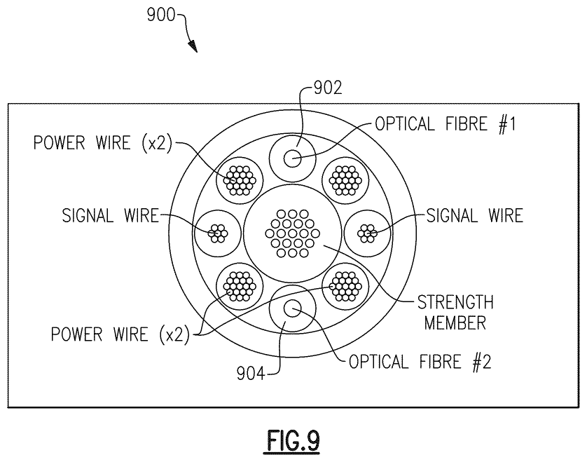

For example, the processing engines 708a, 708b can perform the operations of the flowchart shown in FIG. 8, or any of those described in more detail in U.S. Pat. No. 10,582,168, which is incorporated herein by reference in its entirety. FIG. 8 shows a flowchart 60 of a control routine that can be used with the system 700 of FIGS. 7A-7B, or by any of the video cameras described herein, to decompress and demosaic image data, according to various embodiments. The flowchart 60 will primarily be described with respect to the system 700 of FIG. 7A for the purposes of illustration.

For example, with reference to FIG. 8, the data received by the processing engines 708a, 708b can be decompressed and demosaiced. Optionally, the cameras 404a, 404b can also be configured to perform the method illustrated by flowchart 60.

With continued reference to FIGS. 7A and 8, the flowchart 60 can begin with the operation block 62, in which the data received by the processing engines 708a, 708b from the cameras 404a, 404b is decompressed. For example, the decompression of the data in operation block 62 can be the reverse of the compression algorithm performed in operational block 58 (FIG. 4). After the operation block 62, the flowchart 60 can move on to an operation block 64.

In the operation block 64, a process performed in operation block 54 (FIG. 4) can be reversed. For example, the inverse of the non-linear compression tuning pre-emphasis curve or the inverse of any of the other functions described above with reference to operation block 54 of FIG. 4, can be applied to the image data. While the flowchart 60 describes applying an inverse look-up table, in other embodiments, the flowchart 60 involves calculating the inverse of the pre-emphasis function using math rather than a stored inverse look-up table. After the operation block 64, the flowchart 60 can move on to a step 66.

In the operation block 66, the processing engines 708a, 708b can demosaic the green picture elements to create full color green image data (e.g., green data values for every pixel). For example, as noted above, all the values from the data components Green 1 and/or Green 2. For example, the green image data from the data components Green 1, Green 2 can be arranged according to the original Bayer pattern applied by the image sensor 18. The green data can then be further demosaiced by any known technique, such as, for example, linear interpolation, bilinear, etc.

With continued reference to FIG. 8, the flowchart 60 can, after the operation block 66, move on to an operation block 68. In the operation block 68, the demosaiced green image data can be further processed. For example, but without limitation, noise reduction techniques can be applied to the green image data. Other image processing technique, such as anti-aliasing techniques, can also be applied to the green image data. After the operation block 68, the flowchart 60 can move on to an operation block 70.

In the operation block 70, the red and blue image data can be demosaiced to create full color red and blue image data (e.g., red and blue values for every sensor pixel). For example, firstly, the blue image data can be rearranged according to the original Bayer pattern. The surrounding elements, can be demosaiced from the existing blue image data using any known demosaicing technique, including linear interpolation, bilinear, etc. As a result of demosaicing step, there will be blue image data for every pixel. However, this blue image data was demosaiced based on the modified blue image data, i.e., blue image data values from which green image data values were subtracted.

The operation block 70 can also include a demosaicing process of the red image data. For example, the red image data can be rearranged according to the original Bayer pattern and further demosaicedby any known demosaicing process such as linear interpolation, bilinear, etc.

After the operation block 70, the flowchart can move on to an operation block 72. In the operation block 72, the demosaiced red and blue image data can be reconstructed from the demosaiced green image data.

In some embodiments, each of the red and blue image data elements can be reconstructed by adding in the green value from co-sited green image element (the green image element in the same column “m” and row “n” position). For example, after demosaicing, the blue image data includes a blue element value DBm-2,n-2. Because the original Bayer pattern of FIG. 3 did not include a blue element at this position, this blue value DBm-2,n-2 was derived through the demosaicing process noted above, based on, for example, blue values from any one of the elements Bm-3,n-3, Bm-1,n-3, Bm-3,n-1, and Bm-1,n-1 or by any other technique or other blue image elements. As noted above, these values were modified in operation block 56 (FIG. 4) and thus do not correspond to the original blue image data detected by the image sensor 18. Rather, an average green value had been subtracted from each of these values. Thus, the resulting blue image data DBm-2,n-2 also represents blue data from which green image data has been subtracted. Thus, in one embodiment, the demosaiced green image data for element DGm-2,n-2 can be added to the blue image value DBm-2,n-2 thereby resulting in a reconstructed blue image data value.

In some embodiments, optionally, the blue and/or red image data can first be reconstructed before demosaicing. For example, the transformed blue image data B′m-1,n-1 can be first reconstructed by adding the average value of the surrounding green elements. This would result in obtaining or recalculating the original blue image data Bm-1,n-1. This process can be performed on all of the blue image data. Subsequently, the blue image data can be further demosaiced by any known demosaicing technique. The red image data can also be processed in the same or similar manners. While FIG. 8 shows one possible method of demosaicing and decompression, other orders of operations or types of operations are possible depending on the embodiment.

While not shown in FIG. 8, the flowchart 60 can further be configured to reconstruct green data where green data in embodiments where green data was transformed by other green data (e.g., where green data was transformed by the cameras 104a, 104b, such as by subtracting an average of Green 1 from Green 2), such as is described in further detail in in U.S. Pat. No. 10,582,168, which is incorporated herein by reference in its entirety.

The image processing engines 708a, 708b can further be configured at block 74 to perform one or more image processing operations on the decoded, demosaiced full-color image data. For example, one or more of tonal processing, color processing, white balance, gamma correction and/or other display processing can be performed at block 74 by the processing engines 708a, 708b.

To perform such operations in real-time, the processing engines 708a, 708b can be configured for high throughput graphics processing, and can each include a graphics processing unit, such as an NVIDIA RTX™ 6000 Ada graphics processing card with CUDA® parallel computing cores, Tensor Cores configured to implement mixed-precision computing by dynamically adapting calculations to accelerate throughput, and 48 GB of graphics memory. Such a graphics processing unit can be perform one or more of the operations described in FIG. 8, for example, at the direction of software implemented by the decode/image processing engines 708a, 708b.

Depending on the embodiment, processing engine 708a, 708b can also be configured to convert the processed video data for delivery via another communication interface or standard. For example, each processing engine 708a, 708b includes specialized hardware and/or software for converting the data for outputting the processed video data in real time via a serial digital interface (SDI). In some such implementations, the processing engines 708a, 708b include an 8K SDI card configured to output quad 12G-SDI in four 4 k links (4×4 k). In other embodiments, each processing engine 708a, 708b engine can be configured to output the data for streaming in real time in a network packetized format such as IP, e.g., over SMTPTE 311M compliant optical cables, e.g., at 10 or 25 Gbps or higher. In other embodiments, the processing engines 708a, 708b can stream the data out over copper wire Ethernet, e.g., at 10 or 25 Gbps or higher.

In the embodiment of FIG. 7A, the processing system 702 includes a central encoding/network interface engine 710 that receives the data from the processing engines 708a, 708b and further processes the data. For example, where the processing engines 708a, 708b outputs 8 k or higher streaming video via Quad 12G-SDI, the encoding/network interface engine 710 can include a switcher configured to receive the SDI streams, switch the streams, and output the switched video streams to an encoder within the encoding network interface engine 710.

The encoding/network interface engine 710 can be configured to encode/compress the data into any desired format. For example, the format can be selected for efficient networked transmission to the cloud or otherwise over a wide area network (WAN) like the Internet, or over a local area network (LAN), depending on the embodiment. Depending on the embodiment, the format can be High Efficiency Video Coding (HEVC), H.264, H.265, MPEG, or some other video codec. In some embodiments, the encoder implements open broadcaster software (OBS) Studio software for streaming video. In some cases the processing engine may not perform the operations of FIG. 8, in which case the processing system 702 can send the data in compressed raw format (e.g., REDCODE RAW) to the network system 704.

The encoding/network interface engine 710 can output the data to a network system 704, such as for example a cloud destination hosted by a cloud provider as Amazon Web Services (AWS). In one embodiment, the network system 704 is a content delivery network (CDN) hosted in the cloud, which can be a geographically distributed group of servers that caches the received video content close to end users.

The content delivery network or other network system 704 can deliver the streamed video content to one or more destination devices 706. Depending on the content delivery network, satellites can be used to deliver the streamed video to the destination devices 706. As indicated by the dashed arrow, the processing system 702 can alternatively deliver the footage directly to the destination device 706, e.g., over a LAN or WAN via IP, without delivering it through the intermediate content delivery network 704.

A variety of different types of destination devices 706 are possible depending on the implementation. In some example implementations, the destination devices 706 are virtual and/or augmented reality headsets configured to receive the streamed 8 k or higher video content in real time for display to users for viewing (e.g., of a concert or sporting event). In other implementations, the destination devices 706 are headsets for virtual production.

In further use cases, the destination devices 706 can include any user display devices, including smartphones, network-connected televisions, tablets, laptops, desktops, or the like. The destination devices 706 in some implementations include one or more LED volume walls or other virtual production panels, such as those of FIGS. 1A-1C, or of FIG. 2.

The processing engines 708a, 708b can be further configured to perform supplemental processing on the decompressed, processed video data. For example, the processing engines 708a, 708b can analyze the video footage using computer vision or other image processing algorithms to extract/identify objects (e.g., footballs, basketballs, race cars) and/or people (e.g., performers, audience members, sports players) in the recorded footage. Such algorithms can leverage artificial intelligence (AI) and/or machine learning (ML) techniques. The supplemental processing can be used to enrich or augment the video feeds, such as by adding metadata to the video feeds or by modifying the footage to add supplemental text or other visual information based on the supplemental processing (e.g., to add a player's name hovering above his or her head and moving with the player, or to add a halo or other visual cue for a hockey puck to make it easier to visually track in real time). Or, where the destination devices 706 are virtual reality headsets, the processing engines 708a, 708b can be used to overlay augmented reality content or otherwise manipulate the video feeds for desired virtual reality presentation prior to delivery to the headsets.

In one implementation, the cameras 404a, 404b are located at different locations in a stadium, where each camera 404a, 404b is configured to capture 8 k live footage during a sporting event. The compressed raw video footage is streamed over cabling 446a, 446b infrastructure (e.g., SMPTE 311M cabling), some or all of which may be pre-existing infrastructure in the stadium, to an outside broadcast (OB) van located in the parking lot of the stadium, and which implements the processing system 702. The processing engines 708a, 708b decompress, demosaic, and otherwise process the compressed raw live footage in real-time, as described. Moreover, the processing engines 708a, 708b can be further configured to perform artificial intelligence (AI) or machine learning (ML) or other supplemental processing on the footage. For example, the processing engines 708a, 708b can tokenize the footage using computer vision, other image processing, and/or AI/ML algorithms, e.g., to track individual players, or otherwise generate supplemental content or information regarding the video feeds.

The supplemental information can be used in a variety of ways. For example, the information can be used to control the cameras 404a, 404b, such as via duplex communication from the processing engines 708a, 708b back to the cameras 404a, 404b over the cables 446a, 446b. In one such case, the supplemental information might include real-time player tracking information, information for tracking a football, hockey puck, or other item associated with the game, derived using an AI/ML-based computer vision analysis or other image processing of the live footage. In such a case, the control information sent to the cameras 404a, 404b can control a gimbal or other mechanism for automatically moving the camera 404a, 404b to track one or more selected players, or to track the action in the game, or to provide supplemented video feeds (e.g., with players visually notated with their name or other text or graphics) or other non-video supplemental information (e.g., player information) back to the camera operators over the cables 446a, 446b.

The supplemental content can be used to enrich the video feeds delivered via the content distribution network 704 to the destination devices 706, or to give production personnel additional information to improve the quality of the live broadcast. For example, a supplemental video feed may be streamed from the processing system 702 via the fiber cables 446 (e.g., SMPTE compliant cables) or via the network system 704 to a display that is viewable by a play-by-play announcer or camera operator. As just one example, the supplemental feed might identify each player in the feed with text hovering above that player, to aid the announcer in accurately identifying the players when announcing the game.

The system 700a can be used for stereoscopic or volumetric capture. For example, two or more cameras 400a, 400b can receive timestamp information from a synchronization generator, and embed the timestamp information into the footage streamed across the cables 446a, 446b. A destination device 706 or other computing device can receive the footage, e.g., from the processing system 702, use the embedded time stamp information to frame align or otherwise synchronize the footage received from the multiple cameras 400a, 400b, and process the footage as desired for playback. For example, the computing device can generate a 3D volumetric digital model that can be viewed from any viewpoint, e.g., for use in a VR headset, display, or other destination device 706. Depending on the implementation, the computing device that performs the volumetric or other 3D processing can be a server local to the destination device 706, a server in the cloud system 704, or a computing device in the processing system 702, such as a server (not illustrated) that receives the processed feeds from the processing engines 708a, 708b, processes the data for 3D/volumetric display, and provides the processed footage to the encoding/network interface engine 710. In an example implementation, the system 700a includes two cameras 400a, 400b positioned back to back with 180 degree fish eye lenses, to capture a 360 degree space. The processing engine can stitch together the footage from the two cameras 400a, 400b to create 3D footage for playback e.g., using timestamps to synchronize during stitching. In another implementation, the system 700a includes an array of cameras 400 (e.g., 6, 10 or more cameras arranged around a subject(s) such as a playing field, court, or actor) positioned to capture volumetric footage of the subject from multiple angles. The computing device that performs the volumetric processing in such an implementation can generate a 3D model of the captured space using the captured streams, and generate stitched together footage for playback from any desired angle or location in the volumetric space using the 3D model, the captured footage, and time stamps to synchronize during stitching.

The system 700 can additionally be configured to allow for direct storage of the compressed raw video footage. For example, FIG. 7B depicts the system 700b streaming real time multi-track footage (e.g., compressed or uncompressed raw digital video) via fiber optic cables 446a, 446b for storing to network storage 712, such as cloud storage or for delivery to one or more other destination devices 706 such as a headset or other display. In this example, the video footage is depicted as bypassing the processing engines 708a, 708b because the data is not decompressed and processed, but sent for storage in compressed raw (e.g., REDCODE RAW R3D) format. However, the data may nonetheless pass through the computers that implement the processing engines 708a, 708b, depending on how the processing system is configured 702. Such a technique might leverage the compression and streaming to store large quantities footage, which would be difficult to store on board even with compression due to the amount of data, such as multi-camera footage from a day long cricket match, or from a multi-day F1 race.

FIG. 7C is a block diagram showing examples of cameras 402a, 402b capable of streaming multi-track digital video (e.g., compressed or uncompressed raw footage) via existing fiber optic cable infrastructure (e.g., SMPTE cabling infrastructure), directly to storage 714. The storage 714 can be a local array of drives located on site at a production site, such as a concert or sporting venue, or movie or television set. In such a case, the compressed raw footage can advantageously be streamed over existing fiber cabling infrastructure. Such direct streaming can alternatively be to another destination device such as a headset, other display, or computing device.

Unless the context indicates otherwise, throughout the description and the claims, the words “comprise,” “comprising,” “include,” “including” and the like are to generally be construed in an inclusive sense, as opposed to an exclusive or exhaustive sense; that is to say, in the sense of “including, but not limited to.” Conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively.

While certain embodiments have been described, these embodiments have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and acts of the various embodiments described above can be combined to provide further embodiments. The accompanying claims and their equivalents are intended to cover such forms or modifications as would fall within the scope and spirit of the disclosure.

What is claimed is:

1. A virtual production system comprising:
at least a first virtual production display device;
a first computing device coupled to the first virtual production display device and comprising one or more processors that execute a virtual production control engine, the virtual production control engine configured to control the first virtual production display device such that the first virtual production display device alternatingly displays at least a first virtual production background and a second virtual production background; and
at least a first video camera comprising:
an image sensor configured to capture digital video image frames in response to light incident on the image sensor; and
one or more processors configurable, when the first video camera is operating in a multi-track virtual production recording mode, to:
receive a stream of the digital video image frames from the image sensor, wherein first frames in the stream of digital video image frames capture the first virtual production background and second frames in the stream of digital image frames capture the second virtual production background, wherein the first frames and the second frames alternate in the stream of the digital video image frames; and
separate the stream of the digital video image frames into a first track including the first frames and a second track including the second frames.

2. The virtual production system of claim 1 wherein the one or more processors of the first video camera are further configured to format the first track into a first file, format the second track into a second file, and record the first file and the second file in memory.

3. The virtual production system of claim 1 wherein the first virtual production background corresponds to a non-green screen virtual set and the second virtual production background corresponds to a green screen virtual set.

4. The virtual production system of claim 1 wherein one or both of the first virtual production background and the second virtual production background include recorded motion video, and the virtual production control engine is configured to provide digital video data to the first virtual production display device corresponding to the recorded motion video.

5. The virtual production system of claim 1 wherein one or both of the first virtual video production background and the second virtual production background include computer-generated imagery, and the virtual production control engine is configured to provide digital data to the first virtual production display device corresponding to the computer-generated imagery.

6. The virtual production system of claim 1 wherein the virtual production control engine is further configured to alternatingly output first digital image data corresponding to the first virtual production background and second digital image data corresponding to the second virtual production background.

7. The virtual production system of claim 1 further comprising a synchronization generator coupled to provide a synchronization signal to each of the first computing device and to the first video camera, the first computing device configured in response to the synchronization signal to adjust a timing of the display of the alternating display of the first virtual production background and the second virtual production background, and the first video camera configured in response to the synchronization signal to adjust a timing of the capture of the digital video image frames.

8. The virtual production system of claim 1 wherein the first virtual production display device comprises an LED display.

9. The virtual production system of claim 1 wherein the first video camera includes a fiber optic port configured to connect the first video camera to a fiber optic cable, and wherein the one or more processors of the first video camera are further configured to: compress the digital video image frames into compressed raw digital motion video data, the compressed raw digital motion video data not having been demosaiced; generate network packets comprising the compressed raw digital motion video data; convert an electrical signal carrying the network packets into an optical signal; and provide the optical signal to the fiber optic port for real-time streaming off of the first video camera.

10. A video camera comprising:
a housing;
an image sensor within the housing and configured to output raw, mosaiced digital image data in response to light incident on the image sensor; and
one or more processors configurable, when the video camera is operating in a multi-track virtual production recording mode, to:
receive a stream of digital image frames from the image sensor at a first frame rate, wherein alternating frames in the stream of the digital image frames correspond to N virtual production environment configurations, where N is at least two;
separate the digital image frames into N separate tracks;
format the N separate tracks as N separate files; and
record the N separate files into memory.

11. The video camera of claim 10 wherein the one or more processors are further configured, when the video camera is operating in a multi-track virtual production recording mode, to set a frame rate of the video camera to be at least N*F, where F is a frame rate of each of the N separate tracks.

12. The video camera of claim 10 wherein the one or more processors are further configured, when the video camera is operating in a multi-track virtual production recording mode, to compress the digital image frames.

13. The video camera of claim 12 wherein the compression occurs prior to the separation of the digital image frames into N separate tracks.

14. The video camera of claim 12 wherein the compression occurs after the separation of the digital image frames into N separate tracks.

15. The video camera of claim 10 further comprising a plurality of video streaming output ports, and the one or more processors are further configurable, when the video camera is operating in a multi-track virtual production recording mode, to output the N separate tracks for streaming off the video camera via the plurality of video streaming output ports.

16. The video camera of claim 10 further comprising a plurality of video streaming output ports, and the one or more processors are further configurable, when the video camera is operating in a multi-track virtual production recording mode, to output the N separate files for streaming off the video camera via the plurality of video streaming output ports.

17. The video camera of claim 10 wherein the video camera further comprises a fiber optic port supported by the housing and configured to connect the video camera to a fiber optic cable, and wherein the one or more processors of the video camera are further configured to: compress the digital image frames into compressed raw digital motion video data; generate network packets comprising the compressed raw digital motion video data; convert an electrical signal carrying the network packets into an optical signal; multiplex the optical signal using wavelength division multiplexing; and provide the multiplexed optical signal to the fiber optic port for real-time streaming off of the video camera.

18. The video camera of claim 17 wherein the fiber optic port comprises an SMPTE compliant connector.

19. The video camera of claim 17 wherein the housing comprises a camera body housing containing the image sensor and a module housing releasably attached to the camera body housing, wherein the module housing supports the fiber optic port.

20. The video camera of claim 19 wherein the one or more processors include at least a first processor within the camera body housing and at least a second processor within the module housing.
